(19) United States
(12) Patent Application Publication
(10) Pub. No.: US 2011/0025503 A1
(43) Pub. Date: Feb. 3, 2011

(54) Item tracking in storage drawers

(76) Inventor: Frederick Michael Weaver, Huntersville, NC (US)

Correspondence Address: FREDERICK MICHAEL WEAVER, 8916 HUNTERS POINTE, HUNTERSVILLE, NC, 28078, US

(21) Appl. No.: 12/462,025

(22) Filed: Jul. 28, 2009

(51) Int. Cl. G08B 13/14

(52) U.S. Cl. 340/572.1

(57) ABSTRACT

An item monitoring system for tracking and reporting absence of items such as tools from assigned storage locations. Non-contact sensors are used to capture a mosaic of sensed areas that are processed and compared to previous sensed areas identifying change in the presence or absence of items. When a change is detected the item inventory for the storage location is changed to reflect latest status of present or absent. Scaled to a plurality of storage drawers the item monitoring system provides automatic item inventory status for large storage cabinets which may be linked to a central processing system or queried by hand held terminal.

### FIELD OF THE INVENTION

The present invention relates to unattended item tracking, such as tool tracking, providing awareness of missing tools from their storage drawers within storage cabinets.

### BACKGROUND OF THE INVENTION

After depot or flight line maintenance work orders one or more tools could remain in an airframe causing the airframe to crash during its mission. The resultant loss of life and property, including third party losses on the ground, is both tragic and endangers mission critical operations.

A wide variety of efforts have been undertaken to insure that all tools are replaced to their assigned storage locations typically focused on manual inventory reviews of each drawer to insure that all tools used for a job are back in their storage location or involving marking each tool with a code that is read by a scanner or by RFID tag associated with each tool. Manually based tracking of tools is a time consuming activity at the end of each work order and is subject to human error.

There is a need for a reliable way to insure that all tools used for a job have been replaced to their storage location without requiring individual marking and/or associated readings of identification markings. Any solution to this problem should be cost effective, be able to detect that a tool of any size is missing at the close of a work order and not require individual tool marking or scanning.

The method should be a simple to implement, automatic in nature and clearly alert when a tool is missing at the time of closing a work order so the mechanic can readily recognize the missing tool problem for immediate action. The method should be compatible with automated reporting systems keeping track of tool uses, withdrawal and return of individual tools and attempts to close work orders whether successful or a failure due to a missing tool.

### PRIOR ART

Allen in U.S. Pat. No. 6,915,952 the tracking of a large number of tools, the tools are kept in sets with each set having a container. A silhouette of each tool stored in the container is printed at the point of storage along with a dot matrix code that has stored in binary code a description of the tool, the part number, and an identification of the kit of which it is a part. The associated tool has etched into the surface thereof a data matrix code containing the same information as the code printed at the point of storage. The data matrix codes are readable by a scanner and a record of all the tools is maintained on a computer.

Hetzer in U.S. Pat. No. 6,568,593 discloses a system for identifying tools and/or dies (1, 2, 4) of machine tools and especially of punch presses includes at least one identification marking (6, 7, 8) for each tool and die (1, 2, 4), a scanning device (19) for reading the markings (6, 7, 8), and an evaluation unit for analyzing the scanned data. The markings (6, 7, 8) are removably attached to their associated tools and dies (1, 2, 4) and, when detached, they are accessible to the scanning device (19) for the scanning process. In executing a procedure utilizing the aforementioned system, the markings (6, 7, 8) associated with the tools and dies (1, 2, 4) are detached from these tools and dies (1, 2, 4) and are subsequently scanned. The scanned data can be processed by the machine tool computer to facilitate its efficient operation.

Roxby in U.S. Pat. No. 6,533,181 describes an automated method for creating impressions of machine-readable encoded symbology using thermojet type solid object printing technology. This is accomplished by electronically transmitting a software file containing a part identification symbol representation in Computer Assisted Drawing (CAD) software format to a ThermoJet™ type solid object printer where tiny droplets of a wax like material are deposited in successive layers to form a three-dimensional pattern insert containing representations of the encoded symbology for combination with a pattern replica of a part to be encoded by said symbology. A casting mold is thereafter formed from the combined pattern and a casting is made from the mold to result in a machine readable 2D Data Matrix type encoded, directly marked, part.

Baldur in U.S. Pat. No. 6,176,434 discloses an identification structure providing a plurality of minute holes arranged in a code on a precision machine contact surface of the object to be identified. The holes are of such a small diameter and sufficiently deep depth that they do not interfere with or detract from the function of the object identified, but any attempt to remove them by grinding or otherwise, degrades or destroys the proper functioning of the object identified. The holes can be formed into a binary code which in one aspect depends on each hole being in one of two alternative positions. In another possible arrangement, the binary code can depend on the presence or absence of a hole in a particular position and a check sum can be included to prevent tampering or alteration. Electrical discharge machining provides an excellent fabrication technique. Placing the identification structure on the inside of the barrel of a gun is one example of an application. The ideal location for the holes, of the identification structure, being generally along the groove in the rifling adjacent to the railing edge of a land area in the barrel of the gun. An appropriate fiber optic device can be used to read the code in such a location.

Nakamura in U.S. Pat. No. 5,971,130 discloses a workpiece identifying method is provided, being characterized in that a plurality of identification areas of plural columns and rows are plotted in an identification mark providing region provided in the area of the unused portion of a workpiece or a product, identification holes are formed in the proper number of identification areas, whereby an identification mark is provided to the workpiece or the product. A workpiece is produced with identification holes formed in the proper number of identification areas. An identifying method for detecting the identification holes formed in the proper number of identification areas of the workpiece and workpiece identification apparatus are also provided. Sheet metal machining apparatus is further provided, having the workpiece identification apparatus placed in a workpiece feed device side or a carry-away device side for a sheet metal work machine. Thus, an identification mark is easily and surely provided to the workpiece, making it easy to identify the same.

Allen in U.S. Pat. No. 5,320,223 discloses an insert for a tool box drawer or the like has a first lower layer of compressible material such as foam above which is a second upper layer of compressible material. The second upper layer of compressible material has a plurality of cut outs therein, each cut out being in the shape of the silhouette of the item or tool to be retained therein. A film of material is bonded between the first layer of compressible material and the second layer of compressible material such that the cut out portions become pockets. Labels are provided at the bottom of each pocket by printing information on either the first layer of compressible material or on the film with the printing positioned so as to be visible through the cut out portions of the upper second layer of compressible material. Where the lower layer of compressible material is non-porous, the film is not required.

Rapp in U.S. Pat. No. 4,720,907 discloses a system for marking and identifying objects, particularly work implements such as tools and work piece holders required in manufacturing processes, which has modules (4) with electronically readable markings, which modules (4) are to be arranged on the objects (1) to be marked, as well as an evaluating device having at least one pick-up capable of reading the markings. Each module contains at least one oscillating circuit (5, 6, 7) to produce a characteristic resonant frequency or resonant frequency combination. The number of different resonant frequencies or resonant frequency combinations provided corresponds to the number of different elements in the selected characterizing code, and the resonant frequency or resonant frequency combination of each module (4) is selected according to one of these frequencies or frequency combinations. The modules (4), which are to be fixed to the object (1), are selected and arranged according to the elements necessary for the representation of the marking of the object (1) in the selected code.

Allen in U.S. Pat. No. 6,840,451 discloses to track a large number of tools, the tools are kept in sets with each set having a container. A silhouette of each tool stored in the container is printed at the point of storage along with a data matrix code that has stored in binary code a description of the too, the part number, and an identification of the kit of which it is a part. The associated tool has etched into the surface thereof a data matrix code containing the same information as the code printed at the point of storage. The data matrix codes are readable by a scanner and a record of all the tools is maintained on a computer.

Mohr in U.S. Pat. No. 6,989,749 discloses an electronic check out system which utilizes radio frequency check out devices to check out tools from a centrally located tool storage facility and to identify the individual checking out the tool. The electronic check out system includes readers located a tool boxes and the central storage facility exit to identify the tool and the user of the tool as well as the time and date the tool was removed from the storage facility.

Ballin in U.S. Pat. No. 7,394,380 discloses a method for tracking objects, including identifying and locating an object using a first method, identifying and locating a person using a second method, and associating the object and the person.

Higham in U.S. Pat. No. 7,348,884 discloses an RFID for cabinet for monitoring items having an RFID tag includes a cabinet having at least one locking front door. An RFID detector is used for monitoring each item placed within the cabinet and is located within the interior of the cabinet. A computer is coupled to the RFID cabinet and controls opening and closing of the front door and is configured to receive an input that identifies the user. In this way, the computer is configured to periodically record data read from the RFID tags by the RFID detector.

Holmes, William K.; et al. in 20040104652 discloses a cabinet having a plurality of drawers, each drawer having at least one compartment. The cabinet includes a computer and a panel pivotally coupled to one of the drawers. The panel is disposed in a covering relationship with the compartments within the drawer and includes at least one opening. The opening corresponds with the compartment. A cover is pivotally connected to the panel and covers the opening. A locking mechanism is interconnected with the drawer and the cover. The locking mechanism receives a signal from the computer to position it in one of a locked and unlocked position.

Sriharto, Timur; et al. in 20030117281 discloses a dynamic control containment unit for holding a plurality of discrete items, including a signal emitting mechanism associated with each of the plurality of discrete items, an enclosed housing having at least one receptacle accessible by a user and having at least one of the plurality of items contained therein, a passive signal receiving mechanism in communication with the receptacle for receiving signals emanating from the signal emitting mechanism and a securement system configured to prevent unauthorized access to the dynamic control containment unit. A controller is in communication with the signal receiving mechanism and initiates actions based upon the signal content.

Creel, Myron Dale; et al. in 20030102970 discloses an improved storage enclosure with the ability to query individual objects within the enclosure in order to verify the presence or absence of each object. It also possesses the capability of wirelessly transmitting this verification information to a central control unit for further processing and maintenance coordination. The proper recording of these verifications will provide increased security against the likelihood of adverse incidents resulting from misplaced objects such as tools. In addition, the storage enclosure may be programmed to report its position, based on proximity to vehicles or other objects having a known position.

Li, et al. in U.S. Pat. No. 6,374,195 discloses a method for tracking and monitoring tools in a multi-user environment is provided. The method assigns a unique identification number to each tool which permits the tool to be tracked for purposes of performing operations on the tool, such as periodic performance verification testing and/or preventative maintenance. A user programs the frequency and time at which the operation is to be periodically performed on a tool, such as performance verification testing or preventative maintenance. The method generates routes which enable the operation to be scheduled and performed on selected tools. Data collected from the operation may be uploaded, permitting the method to monitor the performance and/or operation of the tool. In a preferred embodiment, the method compares tool performance to tool operation and calculates tool set-up parameters to tune the performance of the tool to desired levels.

Each of the above prior art fails to address the disclosed invention's unique aspects which include not requiring individual tool identification by means of indicia or electric tag, not requiring manual inventory procedures and being able to automatically identify the presence or absence of even the smallest tools.

### SUMMARY OF THE INVENTION

The present invention relates to a tracking individual tools periodically used in the performance of work orders. The present invention utilizes the under surface of a drawer to mount at least one sensor that provides a representation of the support surface of the drawer below. For the top most drawer, the underside of the support cabinet provides the support surface needed for the top drawer sensor tracking. The sensor can be in a fixed position relative to the drawer below such that when the drawer below is opened to remove or replace a tool the sensor captures mosaic sensor areas such that the assembled mosaic sensor areas capture the current status of the entire area that passes below the fixed position sensors as the drawer below moves out then back into its closed position. Alternatively, the same end result of an updated plurality of mosaic sensor areas can be achieved by a sensor platform that moves across the span of the storage surface then indexes and repeats the traverse capturing the adjacent strip of mosaic sensor areas and so forth until the entire storage surface is cataloged. In this embodiment the closed drawer need not move rather the sensor platform moves in an orderly manner as required. Both embodiments are similar to an aerial photo survey of a land area, which after image processing, results in a land surface view that can be further processed to derive thematic details. For the tool tracking application the goal is to identify empty tool template locations that should be filled at the time of work order close out or on query. Reporting such empty tool template locations alerts the responsible individual to the problem and the present invention can be linked into the work order close out process such that a close out is prohibited if a single tool is not in its storage location.

### BRIEF DESCRIPTION OF THE DRAWINGS

These and other features and advantages of the present invention will be better understood by reference to the following detailed description when considered in conjunction with the accompanying drawings in which:

FIG. 1A is a perspective view of a toolbox;

FIG. 1B is a perspective view of a toolbox on rollers;

FIG. 1C is a perspective view of a tool cabinet on rollers;

FIG. 2 is a top view of a storage surface illustrating a logical mosaic grid;

FIG. 3 is a top view of stationary sensors mounted to the underside of the drawer above;

FIG. 4 is a top view of a moving platform with X and Y movement controls;

FIG. 5A is a top view of a section of empty template locations;

FIG. 5B is a top view of a section of template with some items in their assigned location and some empty template locations; and

FIG. 6 is a top view of an example storage draw with template containing some items.

### DETAILED DESCRIPTION OF THE SPECIFIC EMBODIMENTS

While the preferred embodiments taught are focused on tool tracking in storage drawers, the same invention enables the tracking of items stored in drawers such as medical supplies or jewelry. One skilled in the art will quickly recognize variations to the basic disclosed art which relate to alternative embodiments that are within the spirit of the disclosed art herein.

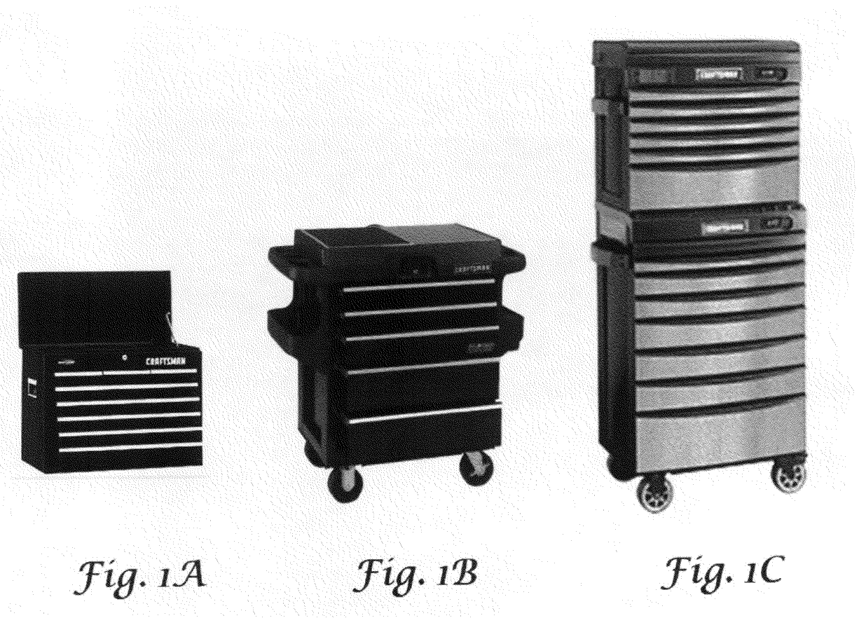

FIGS. 1A, 1B and 1C illustrate representative multi-drawer storage units both fixed in location and on rollers. In each example there are a plurality of drawers. A central theme of the disclosed art is that a sensor element is positioned superior to the collection of items to be monitored whether the drawer periodically moves out and back providing the sensor element area coverage of the storage area or a two-degree of movement X-Y platform moving sensor element is implemented.

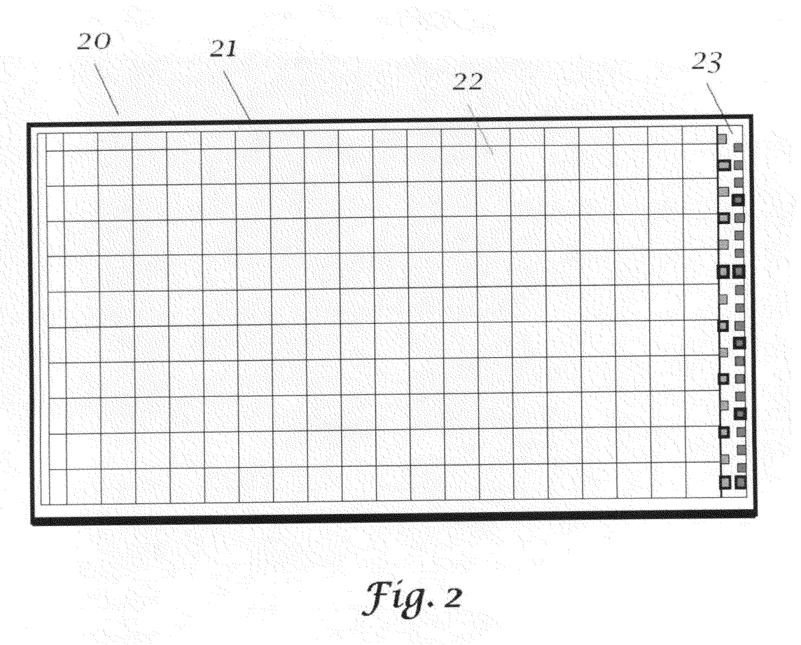

FIG. 2 illustrates how the area within a storage element 20, a drawer, is physically bounded by a wall 21 creating the storage volume within a drawer. Based on the sensor element's area of coverage a grid cell mosaic 22 can be created to organize the sensor element outputs for later processing. When the sensor element is a fixed and the drawer moves to pass under the sensor element then a timing method 23 must be included with the moving drawer so that a position sensor (not shown) can track the out and back drawer movements. Tracking the distance moved by the timing method 23 enables the processor and memory storage element (not shown) to trigger the sensor element (not shown) at the correct moments to enable the capture of the collection of grid cell mosaic 22.

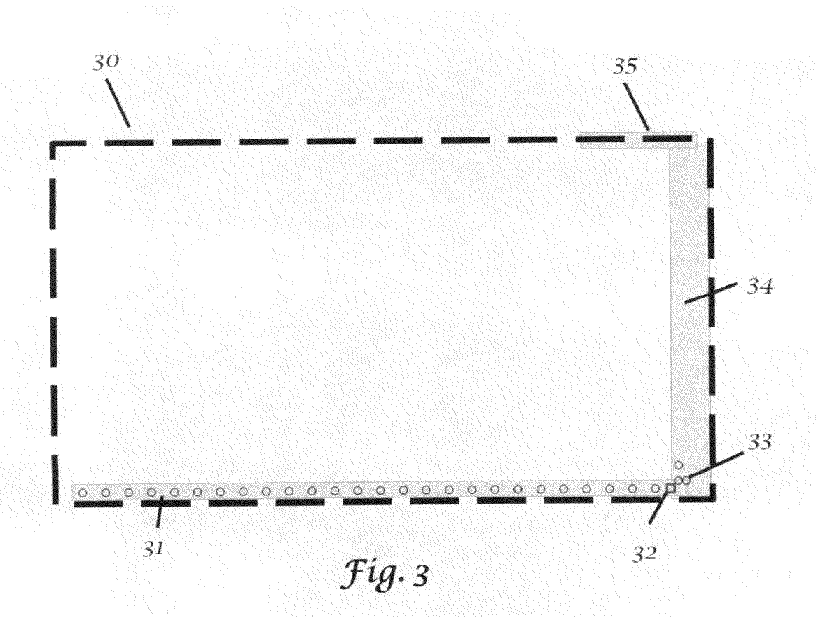

FIG. 3 illustrates the outline 30 of the underside of the superior drawer, or underside of the cabinet for the top drawer to be monitored, for the sensor element 31 controlled by the processor and memory storage element 32 with the position sensor element 33 recognizing the out and back positions when the sensor element 31 should be activated. This applies to the fixed sensor element embodiment of the disclosed invention.

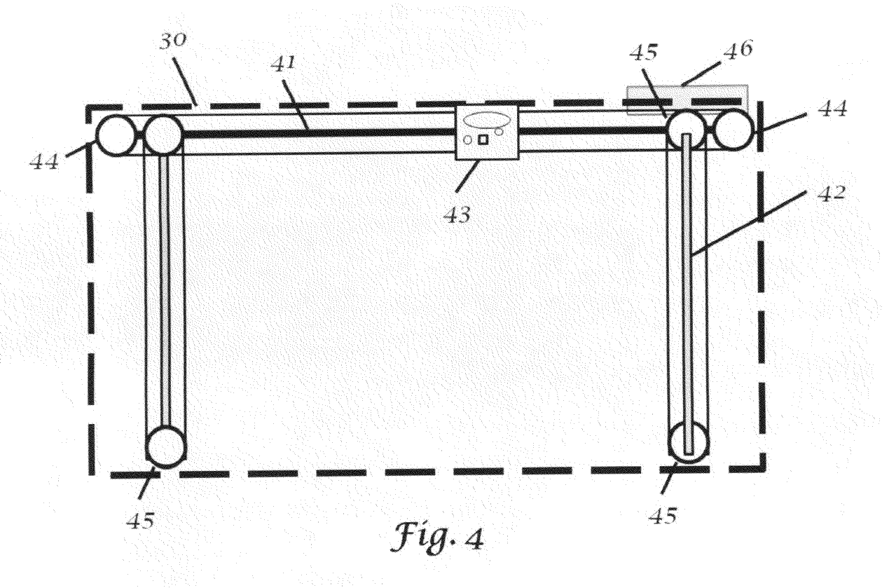

FIG. 4 illustrates the outline 30 of the underside of the superior drawer, or underside of then cabinet for the top drawer to be monitored, for the moving sensor element platform 43. In this embodiment the sensor platform 43 is moved across the width of the storage element below (not shown) by two wheels 44 separated by a structural element 41 with the two wheels having a band around and between them. Mounted to this band is the sensor platform 44 which as a movement element (not shown) is pulsed the sensor platform 43 is moved across the width of the storage element (not shown). By timing the movement element steps the processor and memory storage element that are part of the sensor platform 43 control when each sensor element activates thus capturing individual mosaic sensor readings. Also, the sensor platform 43 is moved in a stepwise manner after each traverse by a second set of wheels 45 at each side of the two wheels 44 that move the sensor platform 43. As such the drawer in a stationary position is surveyed by the sensor platform 44 to capture the collection of grid cell mosaics 23.

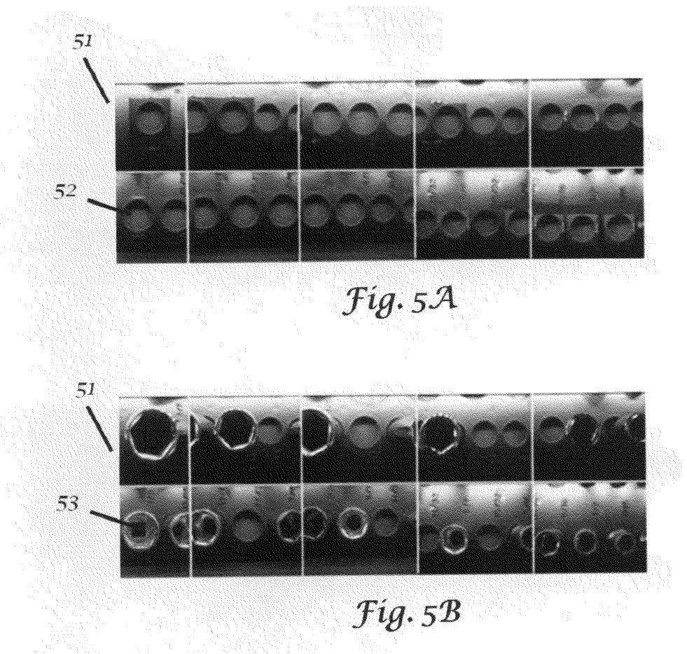

FIG. 5A illustrates a tool element template 51 with a plurality of empty tool element storage locations 52.

FIG. 5B illustrates a tool element template 51 with a plurality of filled tool element storage locations 53.

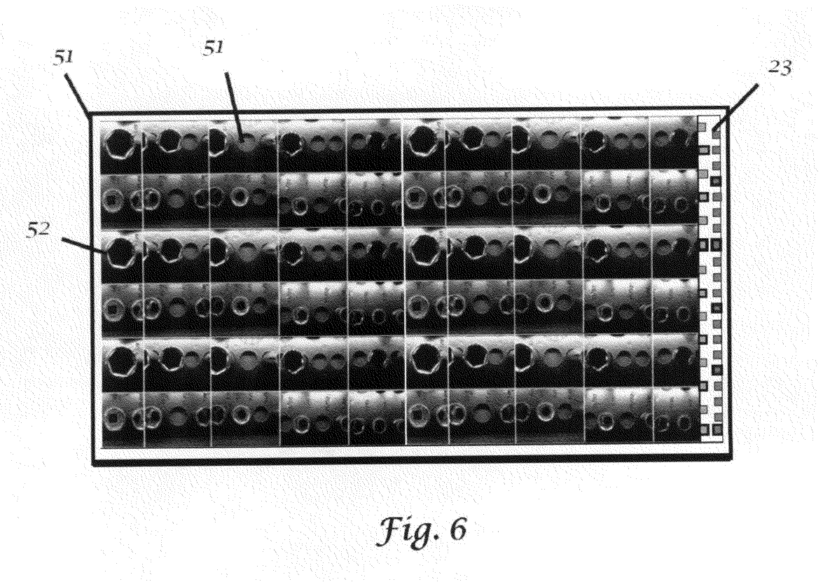

FIG. 6 illustrates an expanded tool element template 51 with both empty 52 and filled 53 tool element storage locations. Also illustrated is the position element 23.

In summary, disclosed is a fixed position sensor element wherein the subject storage element moves out and back thus passing under the fixed position sensor element enabling the capture of a plurality of grid cell sensor mosaics for processing to identify empty and filled tool element storage locations. Also disclosed is a moving platform sensor element wherein the subject storage element is stationary in a closed position while the sensor platform moves in an orderly manner to capture the desired grid cell sensor mosaics for processing to identify empty and filled tool element storage locations.

As one skilled in the art will recognize the sensor element can be implemented through a plurality of cost effective digital imagers such as the kind used in cellular phones with proper lens and mosaic size selection. Current digital imager technology enables digital focusing which further enhances the scope of the sensor's utility. The storage drawer microcontroller and image memory storage and control means together with an optical position sensing means are well known to those skilled in the art. After capture of the mosaic pattern of digital images and the storage means is returned to its rest position the processing of individual mosaic pattern digital images can be processed by a master storage cabinet processor means to form a new master mosaic storage drawer image using techniques that are well known to those skilled in the art enabling the comparison of prior to the new master mosaic storage drawer image item inventory to identify items removed and returned. Likewise the control method for moving a sensor platform to traverse the storage drawer width, the step function to move to return across the storage drawer width, and the continuing of such until the needed depth of the opened storage drawer has been covered to gather mosaic digital images is well known to those skilled in the art. One skilled in the arts will recognize there are a variety of sensor mounting and movement embodiments and combinations of embodiments for the disclosed mounting methods and sensor means that can be used to implement the functionality of the desired item tracking in storage drawers. The above described system can also identify misplaced tools by shape recognition.

This system is particularly advantageous to automatically track tools in drawers for depot and flight line maintenance mechanics required to close out each work order with a tool inventory check. As such with a minimum of lost time the maintenance mechanic can confirm all tools are present and accounted for by means of a display or electronic means.

This system is also advantageous to provide remote confirmation of each storage element as having all assigned tools in position at the end of each shift.

I claim:

1. An item monitoring system comprising:
at least one item touching a support surface, area of said support surface defined by at least one boundary surface and said support surface capable of linear movement;
at least one sensor element extending in a linear fashion traversing and proximate to said support surface, said sensor element affixed to a stationary mounting element relative to moving said support surface
at least one processing and memory storage element in communication with said sensor element said processing and memory storage element for triggering and receiving the output of said sensor element;
at least one location tracking element said support surface position in communications with said processor and memory storage element controlling times when said sensor element senses said items moving relative to said sensor element when said support surface is moving; and
at least one power reservoir providing power to at least one said processing and memory storage element and at least one said sensor element when said support surface is moving.

2. An item monitoring system according to claim 1 wherein said support surface is a storage drawer element with limited movements in and out of a storage cabinet element as guided by storage drawer channel guides.

3. An item monitoring system according to claim 2 wherein said storage cabinet element is a tool storage cabinet with a plurality of said storage surface elements.

4. An item monitoring system according to claim 2 wherein said support surface is comprised of at least one template element with at least one said item having assigned storage location within said template element.

5. An item monitoring system according to claim 2 wherein said support surface is illuminated by an illumination element interfaced to the said processor and storage element,

6. An item monitoring system according to claim 1 comprising:
at least one said tool storage cabinet;
at least one communications and power backplane in contact with at least one said boundary surface of at least one said storage surface;
at least one said tool storage cabinet master processor and memory storage element, and;
at least one area communication element.

7. An item monitoring system according to claim 6 wherein at least one display element is mounted on at least one said boundary surface visible from the front side of said tool storage cabinet.

8. An item monitoring system according to claim 6 wherein at least one said area communications element is connected by direct or wireless network to a central processing element.

9. An item monitoring system according to claim 6 wherein at least one communications element is mounted on said tool storage cabinet enabling a hand held device to communicate with the said tool storage cabinet said master processor and memory storage element.

10. An item monitoring system according to claim 6 wherein at least one said master processor and memory storage element at least one program processing, comparing and reporting said sensor element outputs identifying said item element when missing from said template element notifying that said item element not present in said storage cabinet element said storage drawer by way of said display element.

11. An item monitoring system according to claim 6 wherein said master processor and memory storage element is interfaced to a personnel identification sensing element such that when said item element is removed from or replaced to said storage drawer element a record of the identification of the individual removing said item element and the date and time is captured and stored.

12. An item monitoring system comprising:
at least one item touching a support surface, area of said support surface defined by at least one boundary surface and said support surface capable of linear movement;
at least one sensor element capable of moving in a linear fashion traversing and proximate to said support surface, said sensor element mounted on a stationary frame element relative to said support surface;
at least one processing and memory storage element in communication with said sensor element said processing and memory storage element for triggering and receiving the output of said sensor element; and
at least one power reservoir providing power to at least one said processing and memory storage element and at least one said sensor element when said sensor element is moving.

13. An item monitoring system according to claim 12 wherein said support surface is a storage drawer element with limited movements in and out of said storage cabinet element as guided by storage drawer channel guides.

14. An item monitoring system according to claim 13 wherein said storage cabinet element is a tool storage cabinet with a plurality of said storage surface elements.

15. An item monitoring system according to claim 13 wherein said support surface is comprised of at least one template element with at least one said item having assigned storage location within said template element.

16. An item monitoring system according to claim 13 wherein said support surface is illuminated by an illumination element interfaced to the said processor and storage element,

17. An item monitoring system according to claim 12 comprising:
at least one said tool storage cabinet;
at least one communications and power backplane in contact with at least one said boundary surface of at least one said storage surface;
at least one said tool storage cabinet master processor and memory storage element, and;
at least one area communication element.

18. An item monitoring system according to claim 17 wherein at least one display element is mounted on at least one said boundary surface visible from the front side of said tool storage cabinet.

19. An item monitoring system according to claim 17 wherein at least one said area communications element is connected by direct or wireless network to a central processing element.

20. An item monitoring system according to claim 17 wherein at least one communications element is mounted on said tool storage cabinet enabling a hand held device to communicate with the said tool storage cabinet said master processor and memory storage element.

21. An item monitoring system according to claim 17 wherein at least one said master processor and memory storage element at least one program processing, comparing and reporting said sensor element outputs identifying said item element when missing from said template element notifying that said item element not present in said storage cabinet element said storage drawer by way of said display element.

22. An item monitoring system according to claim 17 wherein said master processor and memory storage element is interfaced to a personnel identification sensing element such that when said item element is removed from or replaced to said storage drawer element a record of the identification of the individual removing said item element and the date and time is captured and stored.
